(19) United States
(12) Patent Application Publication
(10) Pub. No.: US 2009/0228669 A1
(43) Pub. Date: Sep. 10, 2009

(54) Storage Device Optimization Using File Characteristics

(75) Inventors: Vadim Slesarev, Redmond, WA (US); Michael Elizarov, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/045,662

(22) Filed: Mar. 10, 2008

(51) Int. Cl. G06F 12/14

(52) U.S. Cl. 711/161; 711/154; 711/E12.103

(57) ABSTRACT

A storage system may have multiple storage devices on which files are stored. The system may determine various performance characteristics for each storage device and select a storage device on which a particular file having a set of characteristics may be stored. The storage system may consolidate disparate storage devices, such as hard disks, solid state memory devices, and other devices into a single virtual storage device accessible to an operating system. A monitoring system may track file usage information and storage device performance and usage, and an optimizer may transfer files to different storage devices to periodically optimize the file placement based on such usage information.

### BACKGROUND

Different storage devices may have different performance and operational characteristics. Two disk drives having the same storage capacity may have different response speeds, different reliability, or other characteristics. Some storage technologies may have different performance characteristics. For example, hard disk drives with spinning storage platters are often very good a streaming large amounts of data but may have longer seek times than solid state storage devices which may have a short seek time but may be poorer at streaming large amounts of data.

Files stored on the storage devices often have different characteristics. The characteristics may define how the files are used, or how the files are constructed. Some files, such as database files, may be used by reading and writing individual portions of the file. Some database files may be constantly in use. Other files, such as video files may be used sequentially. Many video files, such as movie files, may be viewed very infrequently.

### SUMMARY

A storage system may have multiple storage devices on which files are stored. The system may determine various performance characteristics for each storage device and select a storage device on which a particular file having a set of characteristics may be stored. The storage system may consolidate disparate storage devices, such as hard disks, solid state memory devices, and other devices into a single virtual storage device accessible to an operating system. A monitoring system may track file usage information and storage device performance and usage, and an optimizer may transfer files to different storage devices to periodically optimize the file placement based on such usage information.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a device with a storage system.

FIG. 2 is a flowchart illustration of an embodiment of a method for configuring a managed storage solution and monitoring device activity.

FIG. 3 is a flowchart illustration of an embodiment of a method for file creation and file usage monitoring.

FIG. 4 is a flowchart illustration of an embodiment of a method for optimizing files on storage devices.

### DETAILED DESCRIPTION

A storage system having multiple storage devices may store files on specific storage devices based on file and device characteristics. The multiple storage devices may be managed as a group and may be presented to an operating system as a single storage entity.

Different storage devices may have different characteristics or attributes that may make the devices better suited to storing different types of files. For example, hard disk drives that use spinning platters are often very good for file streaming and sequential access. Music, video, and other media files are often well suited for such devices. In another example, solid state devices may be very efficient at random access of relatively small groups of data and may be preferred for database applications.

In a system where two or more storage devices are aggregated and managed together, any differences between the storage devices may be used to determine where a particular file may be stored. A particular storage device may be selected for a specific file or group of files based on the storage device characteristics. For example, a single virtual storage device may be made up of several hard disks. Some of the hard disks may be different than others in various characteristics. Based on the hard disk or other storage device characteristics, a file may be placed on a specific device.

In such an example, an older disk drive may have slower performance and a shorter expected life than a newer disk drive. A single virtual storage device may use the newer disk drive for more sensitive data and for data that may be accessed frequently. The older disk drive may be used for archiving.

In some virtual storage applications, many different storage devices may be present, each with different storage capacity, different bus architectures, different life expectancies, and, in some cases, different storage technologies. The storage devices may be analyzed, categorized, and monitored so that files may be stored on a device that is best suited for the particular file.

Each file may have various characteristics that may be matched to an appropriate storage device. Some files may have structural or ‘static’ characteristics or metadata that may be used to classify the files. For example, a file may contain various metadata such as file type, creating application, user information, importance criteria, or other metadata that may be used to match the file to a particular storage device. A file may also have dynamic or usage characteristics that may assist in classification. For example, a file that is very rarely used may be better stored on a slower storage device and a very frequently accessed file that may be better stored on a device with a quick response time.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

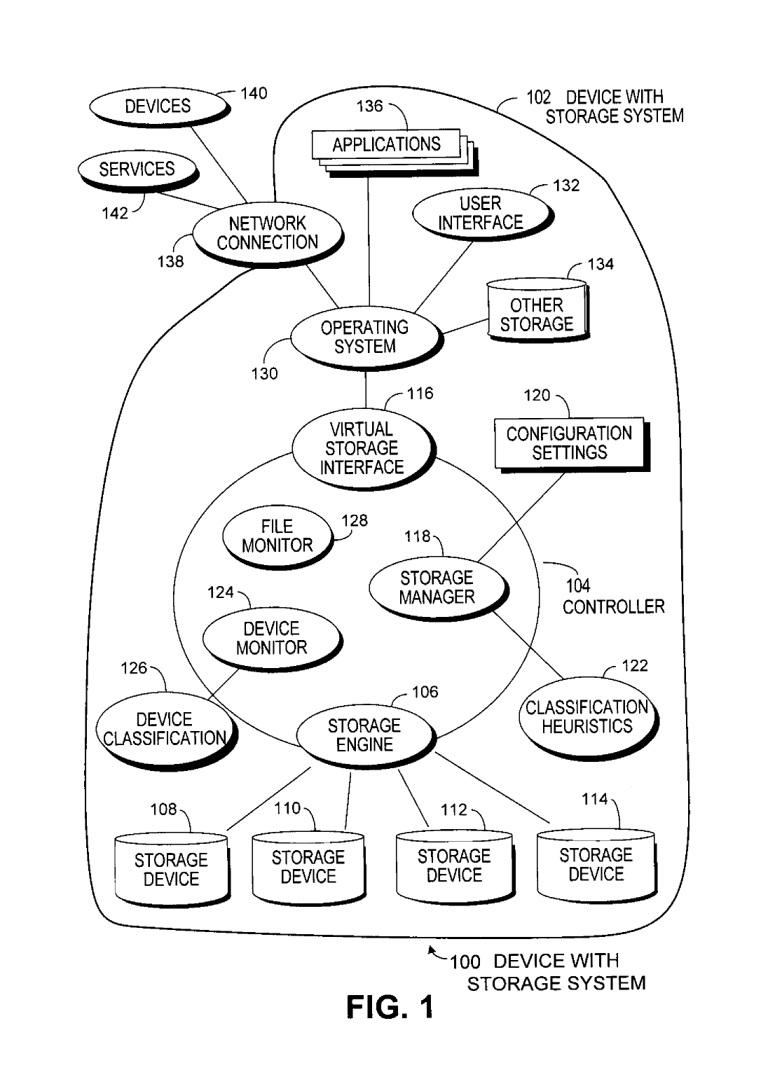

FIG. 1 is a diagram of an embodiment 100 showing a system with a storage system made up of several storage devices. Embodiment 100 is an example of a device that manages several storage devices as a single storage device from an operating system or application point of view. Embodiment 100 is a simplified example of functional elements that may make up such a system.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

The device of embodiment 100 may be a server device, a network storage device, a personal computer with multiple disk drives, or any other device that uses multiple storage devices. In many embodiments, the device 102 may be a device with a programmable processor, and examples may include handheld mobile devices such as cellular telephones and handheld scanners, as well as network appliances, personal computers, server devices, storage area network systems, and any other device.

The device 102 may have a controller 104 that may use a storage engine 106 to interface with storage devices 108, 110, 112, and 114. The controller 104 may be implemented as a hardware interface to multiple storage devices, such as a peripheral device on a printed circuit board or as an integrated circuit or other type of hardware device. In some embodiments, the controller 104 may be implemented in software as a component within an operating system or storage management system. The concepts and functionality described for the controller 104 and the system 102 as a whole may be implemented using any type of system architecture.

In many embodiments, the controller 104 and the storage devices 108, 110, 112, and 114 may be operated as a single storage device. An operating system 130 may send various read and write commands to the controller 104 and the controller 104 may store data on one or more of the storage devices and may read the data as requested. The controller 104 may manage where certain data are stored and may select from among the storage devices 108, 110, 112, and 114 to store various files.

In some instances, the controller 104 may duplicate data by storing a file or group of data on two or more storage devices at the same time. Such duplication may be applied on a file-by-file basis or may be applied to groups of file or all data stored on the storage devices.

The controller 104 may match a file's characteristics to the characteristics of a particular device in order to improve the overall system performance. A file may be placed on a storage device that is best suited for the type of file and the usage of the file, the usage being both anticipated usage and historical usage. In some cases, the controller 104 may move a file from one storage device to another as the file usage changes or as the device characteristics change over time.

The storage devices 108, 110, 112, and 114 may be any type of device capable of storing information. In many embodiments the storage devices may be hard disk drives that store data on a rotating platter. Other embodiments may use solid state memory technology to store data. In some cases, optical, electromagnetic, or other storage media may be used. In a typical high volume storage system, the storage devices may be fixed storage devices, but in other cases, the storage devices may be removable.

Some storage devices may be solid state memory devices that may be removable, such as memory cards that are used in digital cameras and other applications. Some storage devices may be memory devices connected by Universal Serial Bus (USB) and may be solid state or movable media type devices.

The storage devices 108,110, 112, and 114 may be connected to the storage engine 106 though the same or different busses or connections. For example, a server device may connect to storage device 108 using an Integrated Drive Electronics (IDE) bus connection, storage devices 110 and 112 using Small Computer System Interface (SCSI) bus connection, and storage device 114 using USB.

In many embodiments, the storage devices 108,110, 112, and 114 may have different storage capacities. The controller 104 may be capable of using the available storage capacities of each storage device to store data, and may present the aggregate sum of storage capacities of the devices as the capacity of the data storage system. In some embodiments, the controller 104 may use some of the available storage capacity of the storage devices as duplicate storage or redundant storage. Duplicate storage may be areas used to store duplicate or archive versions of a file or group of data for recovery in the event of a failure of one of the storage devices.

The controller 104 may contain a virtual storage interface 116 to the operating system 130. The virtual storage interface 116 may behave similarly to a single storage device from the operating system perspective. The virtual storage interface 116 may receive and respond to read and write queries, status queries, and other functions in a similar manner as a hard disk drive or other storage device. In some cases, the virtual storage interface 116 may be indistinguishable from an interface to a normal storage device. In other cases, the virtual storage interface 116 may be different from a typical storage device.

The controller 104 may contain a storage manager 118. The storage manager 118 may determine the best match between a file and a storage device based on the file characteristics and device characteristics. The storage manager 118 may assign a specific storage device when a file is created and stored, and the storage manager 118 may perform a periodic optimization that may analyze files and devices and move files to a more appropriate location. Such optimization may be performed as the devices age, as new devices are added, and as a usage history for a file is gathered.

The storage manager 118 may use characteristics of a file, along with various configuration settings 120 and a set of classification heuristics 122 to determine an appropriate storage device for a file or group of files.

The storage manager 118 may analyze various file related data, including metadata, usage data, and data derived from the file contents. Many files may have a set of metadata that may be used to assign the file to an appropriate storage device. The metadata may include a file extension, a file type, a creator, an associated application, a creation date, a last-modified date, and other such information.

File usage data may be generated by a file monitor 128. The file monitor 128 may monitor the usage of individual files and generate statistics that may describe how the file is used. Example of usage statistics may include last access, last update, update frequency, average size of data transfer, number of read operations in a given period of time, number of write operations in a given period of time, or any other statistic. In some embodiments, the file monitor 128 may keep a log of file usage and the log may be periodically analyzed to update the statistics for monitored files.

In some embodiments, the storage manager 118 may analyze the contents of a file to determine some characteristics or classifications for the file.

The storage manager 118 may use a classification scheme to organize and classify files into discrete groups. Similarly, the storage devices 108, 110, 112, and 114 may be analyzed and classified into groups. A set of classification heuristics 122 may be used to define the members of the various groups. The classification heuristics 122 may also define how the various groups of files may be related to the groups of storage devices.

In some embodiments, the individual files and devices may not be classified into groups but may be analyzed on a continuum and storage decisions may be based on an algorithm or other logic.

The storage manager 118 may use a set of configuration settings 120 to determine how the storage manager 118 may operate. The configuration settings 120 may define how various categories of files are to be stored, the frequency of optimization, or any other operational or other parameter.

The device monitor 124 may monitor the activity and performance of the storage devices 108, 110, 112, and 114. The device monitor 124 may maintain a device classification 126 that may be used by the storage manager 118 in determining an appropriate location for a particular file or group of files.

The device monitor 124 may measure the capability and performance of the various devices by either actively performing specific performance tests or by passively monitoring the operations performed by each device. For example, the device monitor 124 may track the response time for various read or write commands, monitor the data transfer rate, measure seek time, or may track other parameters as a storage device is in use. In some cases, the device monitor 124 may measure power consumption or other indirect parameters of a device in its operational state.

From the standpoint of the operating system 130, the virtual storage interface 116 may operate as a single storage device as if the virtual storage interface 116. The virtual storage interface 116 may appear as a disk drive or other storage device and may be accessible through a user interface 132, may have files copied to it from other storage devices 132, and may serve as a storage device accessible from various applications 136. In some embodiments, the operating system 130 may make the virtual storage interface 116 accessible through a network connection 138 to various devices 140 and services 142 on a network.

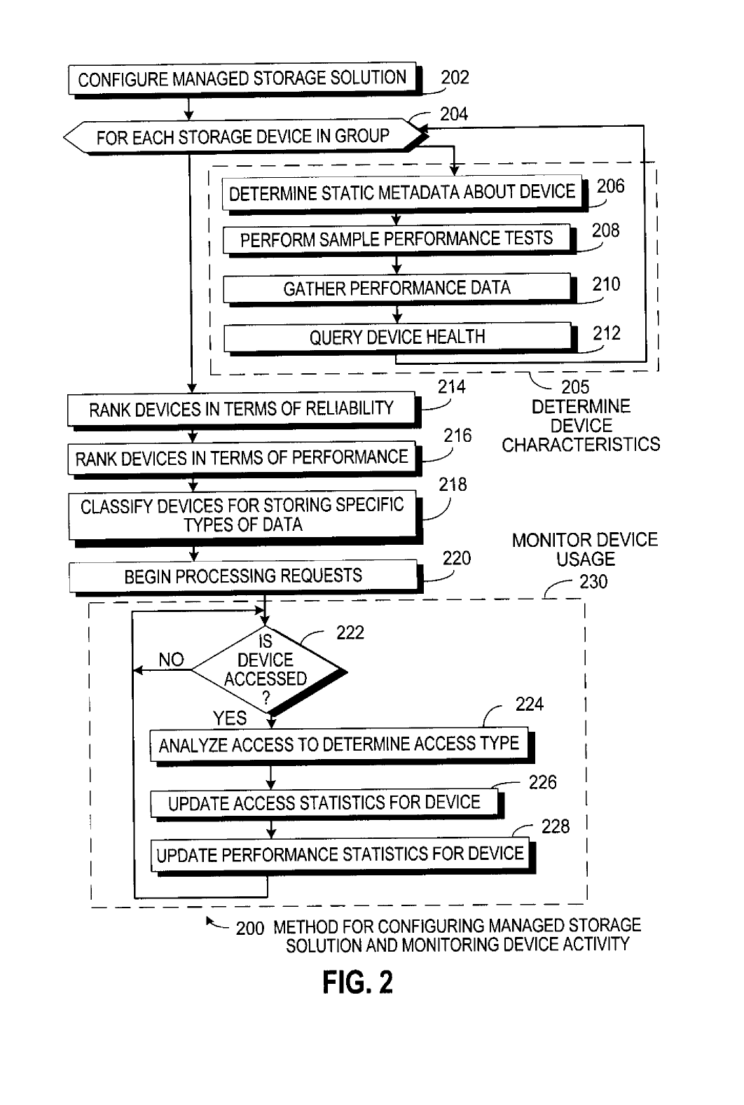

FIG. 2 is a flowchart illustration of an embodiment 200 showing a method for configuring a virtual storage device and monitoring device activity. Embodiment 200 is a simplified example of a sequence that may be used for gathering device information prior to storing data and monitoring the devices once the virtual device is operational.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 illustrates a method for collecting data about storage devices and organizing the data prior to operating a virtual storage device. The method encompasses gathering static and dynamic information, and ranking or sorting the devices based on classification. After the virtual storage device begins operation, each operation that accesses a device may be used to collect and update various ongoing performance metrics.

A virtual storage device may emulate a hard disk drive or other storage device on a system. In many embodiments, a virtual storage device may use multiple disk drives, solid state memory devices, or other storage media and may aggregate the various storage devices into a managed storage device. The virtual storage device may allocate data stored on the virtual storage device to the storage devices under its control.

In many embodiments, the virtual storage device may provide redundant or duplicative storage by placing certain files on two or more different storage devices. By placing a file on two or more storage devices, the file may be recoverable if one of the storage devices fails. In some embodiments, certain files or groups of files may be identified for duplicate storage, while in other embodiments, all files may be stored in such a manner. Individual files or directories of files may be tagged for duplicate storage, and in some embodiments, certain file types may be identified.

In embodiments that use duplicated storage, a file may be first stored on a primary storage device and later copied to a secondary or archive storage device. Such an embodiment may enable fast storage and access but may store only one copy until the duplication operation is performed. In such an embodiment, recent changes to a file on the first copy may not be stored on the secondary or archive storage device for a period of time.

Such an embodiment is useful for embodiments where a background operation may perform the duplicating operation, thus enabling the file read and write operations to be performed quickly.

A different embodiment may perform duplicated storage by writing to two different storage devices simultaneously with each write request. A read request may be performed using either copy of the file, as the files would be kept identical at all times. Such an embodiment is somewhat more secure than an embodiment that performs duplication as a secondary operation, but performs more operations during each write operation and thus may be slower.

When duplicate storage is being used by a virtual storage device or other managed storage application, one version of a file may be stored on a device that has a fast response time, while a copy of the file may be stored on an archive device. The archive device may have different performance and other characteristics than the primary or initial device on which a file is stored.

Many managed storage solutions, including virtual storage devices, may aggregate multiple storage devices and manage the storage devices as a group. A managed storage solution may enable several different storage devices to act as a single storage device, as in the case of a virtual storage device, or may provide other storage functions across multiple storage devices. In many such embodiments, a managed storage solution may assign certain types of files to certain types of storage media or perform various functions using the type of storage media as a factor. Performing duplicative storage of files is one example of such a function.

Embodiment 200 performs an analysis and categorization of storage devices prior to processing storage related requests. The analysis and categorization may be used by a managed storage solution to select specific devices for specific functions.

In block 202, a managed storage solution may be configured. In many embodiments a managed storage solution may be a virtual storage device or may be another storage mechanism that may aggregate several storage devices together and control storage and retrieval across the devices.

The configuration in block 202 may include identifying the storage devices to manage. In many cases, the embodiment 200 may be executed when a new managed storage solution is created or when one or more new storage devices may be added to the managed storage solution.

For each storage device in the group of storage devices in block 204, device characteristics are determined in block 205.

The device characteristics may include determining static metadata about the device in block 206. Examples of static metadata may include the model number and manufacturer of the storage device. The static metadata may also include capacity, media type, bus connection, expected response speed, and other parameters.

The devices that make up a virtual storage device or other managed storage system may be any type of storage mechanism. Any type of storage device may be used, including hard disk drives, solid state storage media, optical storage media, or any other type of storage device. In many cases, the storage media may be nonvolatile, but some embodiments may use volatile memory as well.

In many cases, hard disk drives may be used, and may be connected by various busses or connections. In some cases, a managed storage system may have disk drives connected using two or more different busses, such as USB, SCSI, IDE, SATA, or other connection. In some cases, the connection may be a wireless connection to a storage device.

Each type of connection to a storage device may have different characteristics. For example, storage devices attached through a high speed connection within a computer system may be extremely fast compared to devices connected via USB, wireless, or some other external network connection. Some connections may offer a slow initial connection but may transmit data at very high speeds. Some connections may be better for burst transmissions of data while other connections may be good for streaming or continuous data transmission.

Some storage devices may have different characteristics based on the type of media or device architecture. For example, solid state devices may have very good random access capabilities while spinning media may be good for streaming data. Some devices may operate better with regular write activities, such as some hard disk systems. Other devices, such as certain types of solid state memory devices, may degrade after repeated write activities to the same areas.

Some storage devices may have built in error correction, caching, or other features that may improve or degrade performance in certain situations.

From a device's metadata, many different characteristics may be determined, including expected performance parameters. From these characteristics, different storage devices may be characterized and categorized for use within a managed storage system such as a virtual storage device.

In block 208, a sample performance test may be performed with the storage device and performance data may be gathered in block 210. The performance tests may be any type of test, such as response time, access time, data throughput, or some other test.

The performance data gathered in block 210 may be used to compare to expected data for a specific device. For example, a hard disk device may have a specification that defines an average seek time, and a measured seek time may be substantially higher. Such a discrepancy may indicate that the device is failing, that the file system stored on the device is highly fragmented, or that some other issue may be present.

In block 212, the device health may be queried. Some hard disk drives and other storage devices may have an internal mechanism for monitoring and measuring a device's health. The health may include an estimated time to failure or some other metric indicating reliability. One technology for monitoring and reporting hard disk health is Self-Monitoring, Analysis, and Reporting Technology or S.M.A.R.T., which is a monitoring system to detect and report various indicators of reliability. S.M.A.R.T. is a technology that may be built into the hard disk device and queried using commands over the hard disk interface. Other technologies may also be used for monitoring and reporting reliability and health metrics.

After the device characteristics are collected for each storage device in block 204, the devices may be ranked in terms of reliability in block 214 and in terms of performance in block 216. The devices may be classified in block 218 for storing specific types of data.

Some embodiments may use a ranking or categorization mechanism to classify storage devices before receiving data for storage. Such embodiments may use a set of rules or other heuristics to define the classifications and how a file with a file classification is to be handled by the devices having a device classification.

Other embodiments may have an algorithm, formula, or other logic to decide where to store a file with certain characteristics.

When a group of storage devices are ranked in terms of reliability in block 214, such organization may be used to select a storage device based on the importance of a file. For example, data used by an accounting program may be stored on a high reliability storage device because the loss of such data would be severe. Other data, such as a copy of a movie DVD, may have a low importance and may be recovered by reloading the original DVD.

The performance rankings of block 216 may be used to determine an appropriate storage device based on the predicted or historical use of a file. In the example of a file used by an accounting system, the file may be used quite frequently throughout the course of a business day. Such a file may be preferred to be on a device with a fast response. Archived files and data that is infrequently accessed may be stored on a device with slower response time.

The performance rankings of block 216 may rank devices using different performance parameters. For example, a media playback application may use a particular data rate to playback an audio or video file. The continuous data rate of the application may dictate on which device such media files may be stored. If the files were stored on a device with a slow streaming rate, the playback of the media may be interrupted when the data rate is too slow.

When the devices are classified in block 218, a set of rules, configuration options, or other heuristics may be used to define how files may be handled on the storage devices. In some embodiments, such classification may speed the decision process when a new file is to be created on the managed storage system.

Processing requests begins in block 220. For a brand new managed storage system, the initial requests may be write requests, and after a file is stored, read and write requests may follow.

In some instances, a storage device may be accessed using merely read and write requests. In other instances, a storage device may use higher level commands to access and manipulate files, file metadata, and perform other operations on the storage device.

A process of monitoring device usage of block 230 may begin.

The device usage monitoring activities may gather various performance and usage statistics for each device. The statistics may be used to re-rank devices or to optimize file placement on the devices as time progresses.

When a device is accessed in block 222, the access may be analyzed to determine an access type in block 224. An access type may be a category or classification of access, such as a short random access to a midpoint of a file, a long streaming access of the sequence of a file, or other category of access.

In many cases, each access may enable some performance metrics to be passively or actively captured. For example, a timer may be used to measure the speed at which an access request is processed and the data throughput. In some embodiments, a log file may be kept for each access of each device. The log file may be analyzed to derive various access statistics and performance statistics. In other cases, access statistics and performance statistics may be gathered in real time or near real time.

The access statistics may be updated for each device in block 226 and performance statistics updated for each device in block 228.

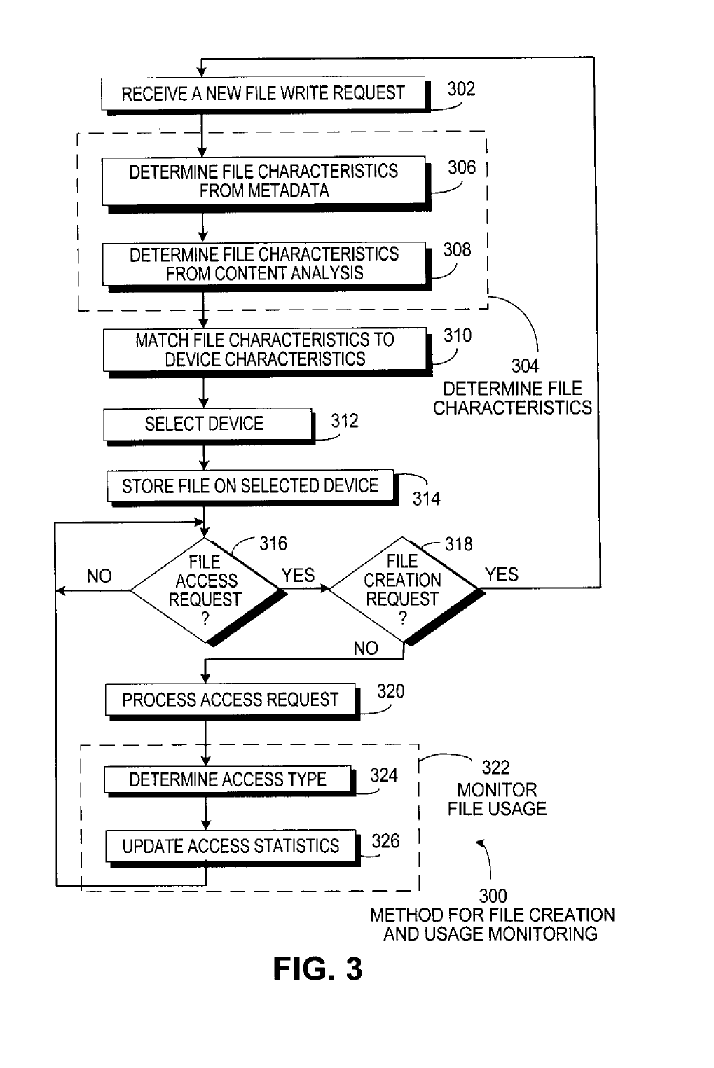

FIG. 3 is a flowchart illustration of an embodiment 300 showing a method for file creation and usage monitoring. Embodiment 300 is a simplified example of a sequence that may be used for storing files on a managed group of storage devices and for monitoring the file usage after storage.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 is an example of a method by which a managed storage system such as a virtual storage device may determine which storage device on which to store a file, then monitor file usage for later optimization.

A new file write request may be received in block 302. After receiving the file write request, various file characteristics may be determined in block 304. The file characteristics may include file characteristics derived from metadata in block 306 and characteristics derived from content analysis in block 308.

The file metadata of block 306 may include file type, file size, applications associated with the file, file directory, user associated with the file, an importance designator, or any other metadata. Each parameter may be used by a heuristic, formula, or other logic to determine a compatible storage device.

For example, the file type and applications associated with the file may be used to assume how the file may be retrieved. For example, a database file associated with an application may be frequently used and randomly and frequently accessed. In another example, a word processor document may be read in its entirety but may be accessed only when the application opens and when the document is periodically stored. In the first example, the file may be stored on a fast response time device and the second file may be stored on a slower response time device.

In another example, files that are associated with a certain directory or portion of a directory structure may be flagged for a specific type of storage. For example, a directory may be identified for archive storage or may be identified for high reliability storage.

After determining file characteristics in block 304, the file characteristics may be matched with device characteristics in block 310 and a storage device may be selected in block 312.

The process of matching file characteristics to an appropriate storage device may be performed in many different manners. In some cases, a device may be selected based on file characteristics, device characteristics, as well as the available capacity of a device to store the file. The file characteristics and device characteristics may be defined in two or three classification groups and matched using a heuristic or rule. In other embodiments, the file and device characteristics may be expressed in a continuum and analyzed using a formula or other calculation. Still other embodiments may use other mechanisms for matching a file to a storage device and selecting the device.

After the device is selected, the file may be stored on the selected device in block 314.

If a file access request is received in block 316 and the request is a file creation request in block 318, the process may return to block 302. If the request is not a file creation request, the access request may be processed in block 320.

In many embodiments, a file access request may be a read request. In some embodiments, the file access request may be other primitive commands such as delete a file, rename a file, or other actions.

The file usage may be monitored in block 322. The monitoring actions may include determining an access type in block 324. The access type may be a classification of an interaction with the file that may be used to access the type of storage that may be applicable for the particular file.

A group of access statistics may be updated in block 326 for the file. In many cases, each use of a file may be logged to determine the frequency of use and the last time the file was used. In many cases, a file may go unused for a long period of time. In some cases, a file may be identified for storage on a high reliability or fast access storage device, but may not be accessed for a long time. In such a case, the file may be moved to a lower speed or archive storage device to make room for other files that may take advantage of the high speed or high reliability characteristics of the first storage device.

The process of matching a file's characteristics to a device's characteristics may be performed at file creation as well as afterwards using a periodic optimization mechanism. Embodiment 300 is one illustration of a mechanism for determining a storage device at the point of file creation. Embodiment 400, illustrated below, is an example of an embodiment for optimization that may be performed periodically to files already stored. The optimization of embodiment 400 may use the historical tracking data collected by the file usage monitoring of block 322 and the device usage monitoring of block 230 in embodiment 200.

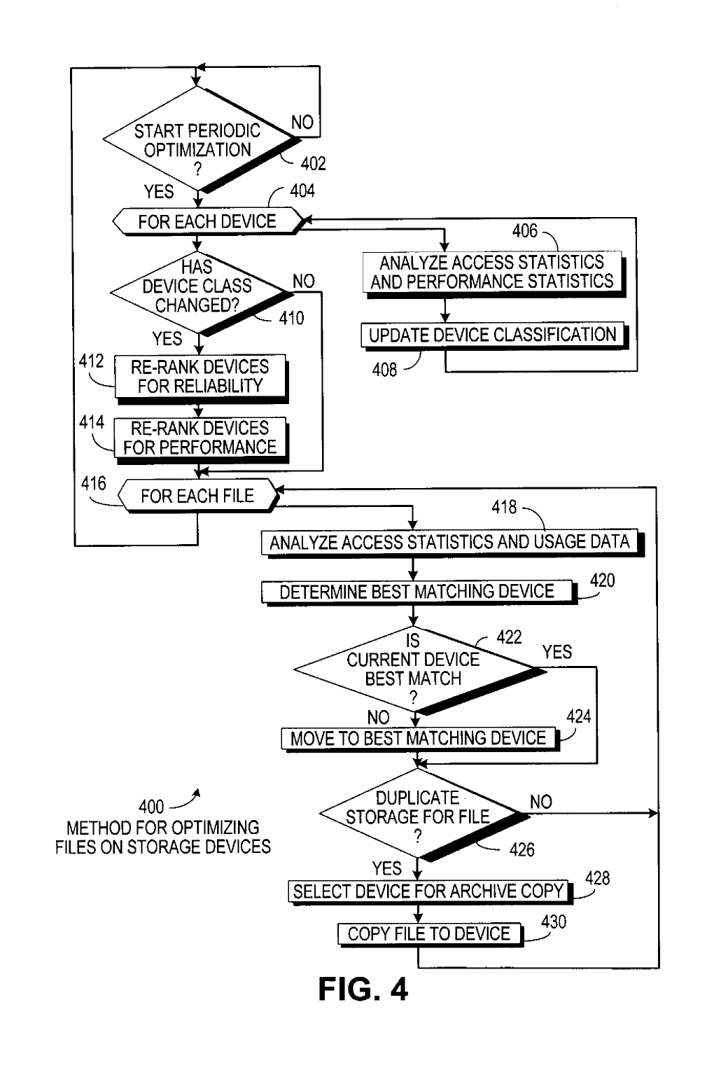

FIG. 4 is a flowchart illustration of an embodiment 400 showing a method for periodically optimizing files on storage devices within a managed storage system such as a virtual storage device. Embodiment 400 is a simplified example of a sequence that may be used to periodically re-analyze or re-characterize storage devices and use historical data to determine the best fit between a file and a storage device.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 is an example of a periodic optimization that may be run on a managed storage system. In many embodiments, some or all of the embodiment 400 may be run as a continual background process. In other embodiments, the method of embodiment 400 may be executed on a nightly, weekly, or monthly basis. Some embodiments may run the embodiment 400 on an as-requested basis.

If the periodic optimization is started in block 402, each storage device may be analyzed in block 404. For each device in block 404, the access statistics and performance statistics may be analyzed in block 406 and the device classification may be updated in block 408. If one or more of the device classifications have changed in block 410, the devices may be re-ranked for reliability in block 412 and re-ranked for performance in block 414. If the device classification has not changed in block 410, the re-ranking steps may be skipped.

For each file in block 416, the access statistics and usage data may be analyzed in block 418. In many cases, a newly created file may be classified and stored on a device based on the expected usage of the file. For example, a database file associated with a business application may be assumed to have a high usage and placed on a storage device with a fast response time. However, if that file is not used very often, the file may be better suited for a slower storage device so that the faster storage device may be allocated to other filed that may be more in demand.

Based on the access and usage statistics, the best matching storage device may be determined in block 420. If the best matching device is not the current device in block 422, the file may be moved to the best matching device in block 424. If the current device is the best matching device in block 422, the file is not moved.

If a file is flagged for duplication, either expressly or as part of a general rule that identifies the file for duplication in block 426, a device may be selected for an archive copy in block 428 and the file may be copied to the device in block 430.

The process of duplication in blocks 426, 428, and 430 may be used to back up sensitive or important files onto a second storage location. The second storage location may be a storage device with slower access speed or may be less capable than a primary storage device for the file.

In many embodiments, the process of duplication may be performed in a background process that may continually operate in a low priority. As files are created or updated, a background process may create a duplicate of the file onto an archive device that is separate from the primary device on which the file is originally stored.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
for each storage device in a group of storage devices, determining a set of device characteristics for said storage devices;
receiving a write request to store a file on said group of storage devices;
determining a set of file characteristics for said file;
selecting one of said storage devices in said group of storage devices by analyzing said set of storage device characteristics and said set of file characteristics; and
storing said file on said one of said storage devices.

2. The method of claim 1 further comprising:
operating said group of storage devices as a single virtual storage device.

3. The method of claim 2 further comprising:
monitoring file usage for said file to determine at least one file usage characteristic.

4. The method of claim 3 further comprising:
optimizing said set of storage devices by analyzing said at least one file usage characteristic and said set of device characteristics to determine an optimized one of said storage devices; and
moving said file to said optimized one of said storage devices.

5. The method of claim 2, said set of file characteristics being derived from metadata.

6. The method of claim 2 further comprising:
determining that said file is to be stored in duplicate and making a copy of said file on a second one of said storage devices.

7. The method of claim 2 further comprising:
identifying a first file with a low usage on a first storage device having a first value for a performance parameter; and
moving said first file to a second storage device having a second value for a performance parameter, said second value being different than said first value.

8. The method of claim 1 further comprising:
monitoring each of said storage device to determine at least one historical performance characteristic for said storage device.

9. The method of claim 8, said at least one historical performance characteristic comprising a characteristic monitored using S.M.A.R.T.

10. A system comprising:
a plurality of storage devices, each of said storage devices having a set of device characteristics;
a controller configured to respond to read and write requests and process said read and write requests with each of said plurality of storage devices;
a storage manager configured to determine a set of file characteristics for a file and select a first one of said plurality of storage devices for storing said file based on said device characteristics.

11. The system of claim 10, said storage manager configured to perform said select when a write request is received for said file.

12. The system of claim 10, said storage manager configured to perform said select after said file has been stored on a second of said plurality of storage devices.

13. The system of claim 10 further comprising:
a file monitoring system configured to monitor at least one usage parameter for files stored on said system.

14. The system of claim 10 further comprising:
a device monitoring system configured to monitor at least one of said device characteristics.

15. The system of claim 10, said set of file characteristics being derived from file metadata.

16. The system of claim 10, said set of file characteristics being derived from file metadata.

17. The system of claim 10, said set of file characteristics being derived from file contents.

18. The system of claim 10, said controller configured to present a single virtual storage device to an operating system.

19. A virtual disk system comprising:
a plurality of storage devices;
a database of device characteristics for each of said plurality of storage devices;
a virtual storage interface configured to respond to read and write requests for files, said virtual storage interface being further configured to act as a single storage device;
a storage manager configured to determine a set of file characteristics for a file and select a first one of said plurality of storage devices for storing said file; and
a storage engine configured to store said file on said first one of said plurality of storage devices.

20. The virtual disk system of claim 19 further comprising:
a storage device optimizer configured to analyze said set of file characteristics for a second file and said device characteristics for each of said plurality of devices and determine an optimized one of said plurality of devices; and
said storage engine configured to move said second file to said optimized one of said plurality of devices.
